(19) United States
(12) Patent Application Publication
(10) Pub. No.: US 2026/0329158 A1
(43) Pub. Date: Oct. 22, 2026

(54) CHILDREN'S CAMERA CASE

(71) Applicant: Shenzhen Meimei Trading Co., LTD, Shenzhen (CN)

(72) Inventor: Meimei YAN, Shenzhen (CN)

(73) Assignee: Shenzhen Meimei Trading Co., LTD, Shenzhen (CN)

(21) Appl. No.: 19/204,769

(22) Filed: May 12, 2025

(30) Foreign Application Priority Data
Apr. 18, 2025 (CN) 202520754111.5

(51) Int. Cl. G03B 17/56; G03B 17/02

(52) U.S. Cl. CPC G03B 17/566; G03B 17/02; G03B 2217/002

(57) ABSTRACT

A children’s camera case includes a housing, a card, and a magnetic attraction assembly. The housing is adapted to external dimensions of the camera, the card is disposed at the periphery of a lens of the camera, and the card is magnetically connected to the housing optionally by the magnetic attraction assembly.

### CROSS-REFERENCE TO RELATED APPLICATIONS

This application claims priority benefits to Chinese Patent Application No. 2025207541115, filed on Apr. 18, 2025, the contents of which are incorporated herein by reference.

### TECHNICAL FIELD

Embodiments of the present disclosure relate to the field of camera cases, and in particular, to a children’s camera case.

### BACKGROUND

The existing children’s cameras and their cases usually lack entertainment and interactivity, which fails to effectively attract children’s attention. As a result, children are easily distracted or unwilling to cooperate during shooting, affecting the shooting results.

The existing camera cases are usually not easily to replace, lacking flexibility and fun.

### SUMMARY

Embodiments of the present disclosure provide a children’s camera case capable of attracting children’s attention, helping children stay more focused during shooting, thereby improving the shooting quality. This is especially important for selfies or family photography where keeping children’s eyes focused on the lens is a key challenge.

Embodiments of the present disclosure provide a children’s camera case sleeved on a camera. The children’s camera case includes a housing adapted to external dimensions of the camera; a card disposed at the periphery of a lens of the camera; and a magnetic attraction assembly, a part of the magnetic attraction assembly being provided in the housing, and the other part of the magnetic attraction assembly being provided in the card, where the card is magnetically connected to the housing optionally by the magnetic attraction assembly.

In some implementations, the card includes a card slot having an inner arc dimension adapted to an outer edge of the lens of the camera.

In some implementations, the card slot is circular or arc-shaped, and an edge of the card slot is adapted to the outer edge of the lens of the camera.

In some implementations, the children’s camera case further includes a lens through hole provided in the housing, where the lens of the camera protrudes from inside the lens through hole to the outside when assembling.

In some implementations, the children’s camera case further includes a lens collar disposed on a peripheral side of the lens through hole, where the lens collar is sleeved at the periphery of the lens of the camera after the camera is fitted with the camera case, and the card slot is adapted to the shape of the lens collar.

In some implementations, the card includes a mounting surface and a display surface, where the mounting surface is adjacent to the housing and is secured by the magnetic attraction assembly, and the display surface is used to display patterns.

In some implementations, an outer surface of the housing and the mounting surface of the card are provided with placement slots respectively, and the magnetic attraction assembly is fixedly mounted in the placement slots.

In some implementations, the housing is further provided with a first placement slot and a second placement slot which are disposed at two sides of the lens of the camera, respectively. The card further includes a third placement slot and a fourth placement slot which are disposed corresponding to the first placement slot and the second placement slot in position, respectively. The magnetic attraction assembly includes a first magnetic attraction member, a second magnetic attraction member, a third magnetic attraction member, and a fourth magnetic attraction member which are fixedly disposed in the first placement slot, the second placement slot, the third placement slot, and the fourth placement slot, respectively. When the first magnetic attraction member is magnetically connected to the third magnetic attraction member and the second magnetic attraction member is magnetically connected to the fourth magnetic attraction member, the card is fixedly connected to the housing.

In some implementations, after magnetically connected to the housing, the card is disposed directly above the lens through hole, making it easier for children to focus their eyes on the lens during shooting, thereby improving the shooting effect.

In some implementations, the card is made of one of board, silicone, polyvinyl chloride (PVC), polycarbonate (PC), polyurethane (PU), polypropylene (PP), and thermoplastic polyurethane elastomer (TPU), or a composite synthesized from any combination of the above.

In some implementations, the card is provided with a seventh magnetic attraction member on an inner side of its card slot, and the card is magnetically connected to an outer surface of the lens of the camera optionally by the seventh magnetic attraction member.

In some implementations, the first placement slot and the second placement slot may be arranged symmetrically with respect to a center point of the lens of the camera.

In some implementations, the first magnetic attraction member has a thickness greater than a slot depth of the first placement slot, and the second magnetic attraction member has a thickness greater than a slot depth of the second placement slot.

In some implementations, the third magnetic attraction member has a thickness smaller than a slot depth of the third placement slot, such that the first magnetic attraction member is partially accommodated in the third placement slot when the first magnetic attraction member is magnetically connected to the third magnetic attraction member. The fourth magnetic attraction member has a thickness smaller than a slot depth of the fourth placement slot, such that the second magnetic attraction member is partially accommodated in the fourth placement slot when the second magnetic attraction member is magnetically connected to the fourth magnetic attraction member.

In some implementations, the first magnetic attraction member, the second magnetic attraction member, the third magnetic attraction member, and the fourth magnetic attraction member are all in flat cylindrical shapes.

In some implementations, a fifth magnetic attraction member is provided on at least one of a peripheral side of the card slot of the card and a peripheral side of the lens through hole of the housing, and a sixth magnetic attraction member or a magnetizable metal body is provided on the other one of the peripheral side of the card slot of the card and the peripheral side of the lens through hole of the housing, allowing the card to be magnetically connected to the housing optionally by the fifth magnetic attraction member and the sixth magnetic attraction member or the metal body.

In some implementations, the fifth magnetic attraction member and/or the sixth magnetic attraction member are annular magnets.

In some implementations, a seventh magnetic attraction member is provided on at least one of the inner side of the card slot of the card and an outer surface of the lens collar, and an eighth magnetic attraction member or a metal body made of iron, cobalt, and nickel is provided on the other one of the inner side of the card slot of the card and the outer surface of the lens collar, allowing the card to be magnetically connected to the outer surface of the lens collar optionally by the seventh magnetic attraction member and the eighth magnetic attraction member or the metal body.

In some implementations, the seventh magnetic attraction member and/or the eighth magnetic attraction member are strip- and arc-shaped magnets.

In some implementations, the first magnetic attraction member, the second magnetic attraction member, the third magnetic attraction member, and the fourth magnetic attraction member may be one or a combination of a permanent magnet, an electromagnet, a soft magnetic material, a rare earth magnet, a bonded magnet, or a flexible magnet.

As can be seen from the analysis, the present invention discloses a children’s camera case. It is ensured that the camera fits snugly into the case by adapting the housing to the external dimensions of the camera, providing a better and more precise match between the housing and the case for enhanced stability. The card is disposed at the periphery of the lens, and the content of the card can attract children’s attention, making it easier for the children to focus on the lens during shooting, and thus improving the shooting effect. The magnetic attraction assembly allows the card to be easily removed and replaced, increasing flexibility and fun.

The inner arc dimension of the card slot is adapted to the outer edge of the lens of the camera, ensuring that the card is accurately mounted around the lens, and thus improving the overall compactness of the case. A variety of materials may be selected for the card, allowing the most suitable material to be selected according to specific needs, thereby enhancing the durability of a product and the comfort experience for a user.

### BRIEF DESCRIPTION OF DRAWINGS

The accompanying drawings of the specification, which form part of the present disclosure, are used to provide a further understanding of the present disclosure, and the illustrative embodiments of the present disclosure and their description are used to explain the present disclosure and do not constitute an undue limitation of the present disclosure, in which:

FIG. 1 is an exploded perspective view of a camera, a camera case, a magnetic attraction assembly, and a card according to a first embodiment of the present disclosure.

FIG. 2 is an overall perspective view of the case mounted on the camera according to the first embodiment of the present disclosure.

FIG. 3 is an exploded perspective view of the card and the camera case in the first embodiment of the present disclosure according to

FIG. 4 is an exploded perspective view of the card and the camera case according to the first embodiment of the present disclosure from another perspective.

FIG. 5 is a perspective view of a magnetic attraction assembly mounted in the card according to the first embodiment of the present disclosure.

FIG. 6 is a perspective view of a magnetic attraction assembly mounted on the camera case according to the first embodiment of the present disclosure.

FIG. 7A is a perspective view showing installation of the camera, the camera case, and the card according to the first embodiment of the present disclosure.

FIG. 7B is a cross-sectional view of taken along line BB in FIG. 7A of the present disclosure.

FIG. 7C is an enlarged view of aera M of FIG. 7B of the present disclosure.

FIG. 8 is an exploded perspective view of a camera case, a magnetic attraction assembly, and a card according to a second embodiment of the present disclosure; and

FIG. 9 is an exploded perspective view of the camera case, the magnetic attraction assembly, and the card according to the second embodiment of the present disclosure from another perspective.

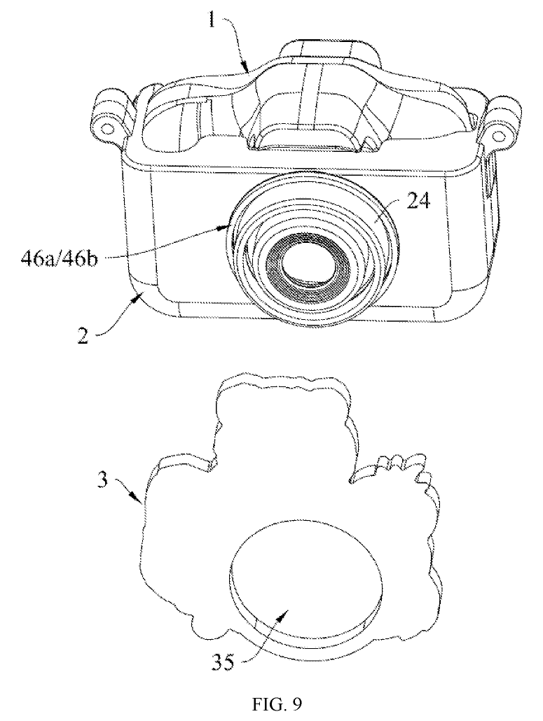

Reference numerals: 1-camera; 10-lens; 2-camera case; 20-housing; 21-first placement slot; 22-second placement slot; 23-lens through hole; 24-lens collar; 3-card; 31-third placement slot; 32-fourth placement slot; 33-mounting surface; 34-display surface; 35-card slot; 4-magnetic attraction assembly; 41-first magnetic attraction member; 42-second magnetic attraction member; 43-third magnetic attraction member; 44-fourth magnetic attraction member; 45-fifth magnetic attraction member; 46a-sixth magnetic attraction member; 46b-metal body; 46c-metal body; 47-seventh magnetic attraction member; 48a-eighth magnetic attraction member; 48b-metal body; 48c-metal body.

### DETAILED DESCRIPTION OF THE EMBODIMENTS

The present disclosure will be described in detail below with reference to the accompanying drawings and in conjunction with embodiments. The various examples are provided by way of explanation of the present disclosure and are not intended to limit the present disclosure. Indeed, it will be clear to those skilled in the art that modifications and variations may be made to the present disclosure without departing from the scope or spirit of the present disclosure. For example, features shown or described as part of one embodiment may be used in another embodiment to create yet another embodiment. Thus, it is expected that the present disclosure encompasses such modifications and variations that are categorized within the scope of the appended claims and their equivalents.

In the description of the present disclosure, the orientation or positional relationships indicated by the terms “longitudinal,” “lateral,” “upper,” “lower,” “front,” “back,” “left,” “right,” ”vertical,” “horizontal,” “top,” “bottom,” etc., are based on the orientation or positional relationships shown in the accompanying drawings, and are intended solely for the purpose of facilitate the description of the present disclosure rather than to require that the present disclosure must be constructed and operated in a particular orientation, and therefore are not to be construed as limitations on the present disclosure. The terms “connected,” “connecting,” and “provided” used in the present disclosure should be understood in a broad sense. For example, it may refer to fixed connection or detachable connection, it may refer to direct connection or indirect connection through an intermediate component, or it may refer to wired connection, a radio connection, or a wireless communication signal connection. The specific meaning of the above terms may be understood by a person of ordinary skill in the art according to the specific circumstances.

One or more examples of the present disclosure are illustrated in the accompanying drawings. Numerical and alphabetic marks are used in the detailed description to refer to features in the accompanying drawings. Similar or analogous marks in the accompanying drawings and description have been used to refer to similar or analogous portions of the present disclosure. As used herein, the terms “first,” “second,” “third,” etc., can be used interchangeably to distinguish one member from another, and are not intended to indicate the location or importance of separate members.

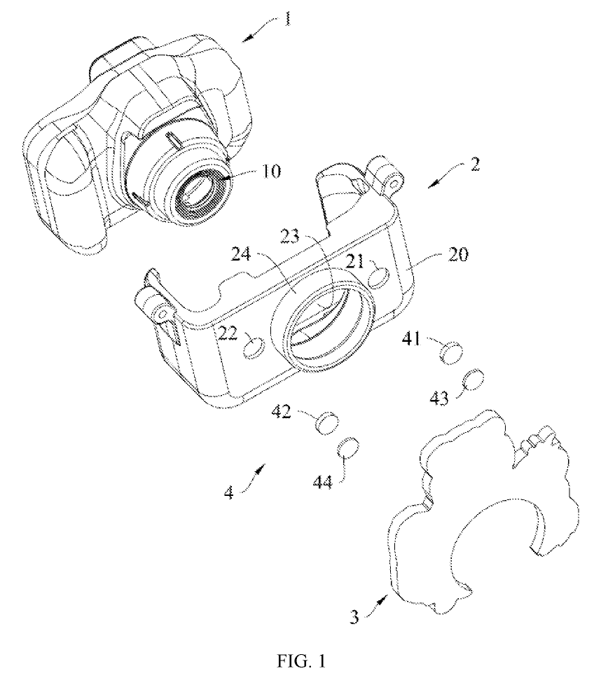

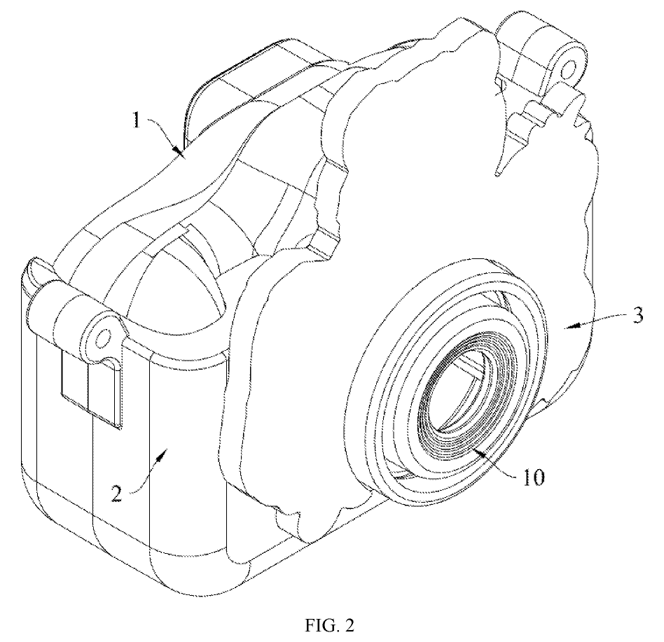

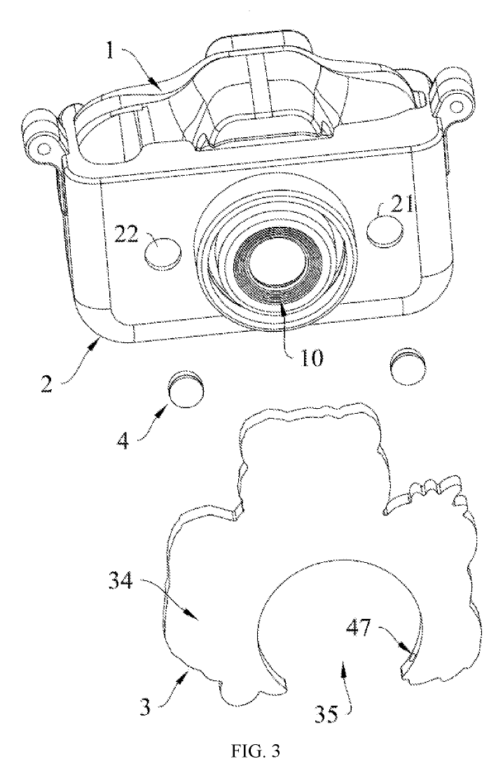

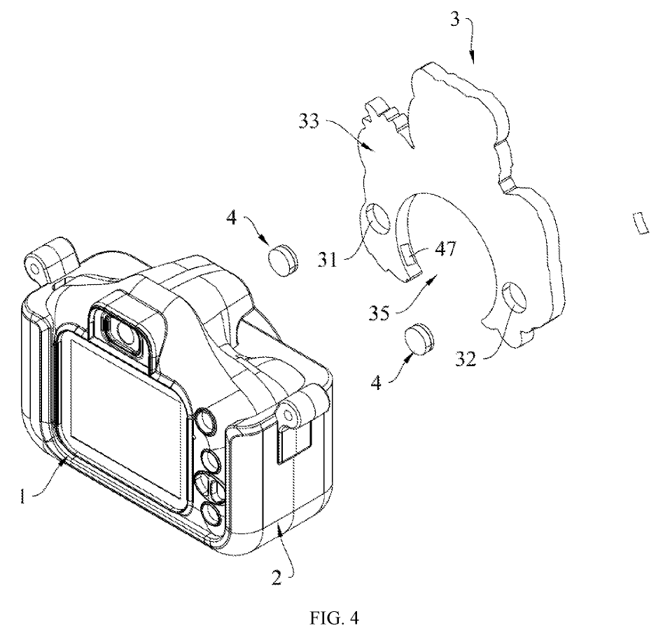

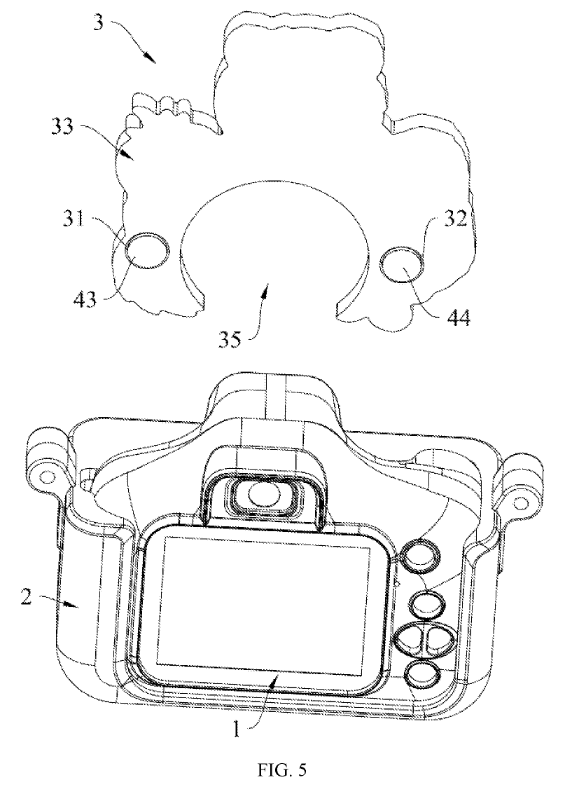

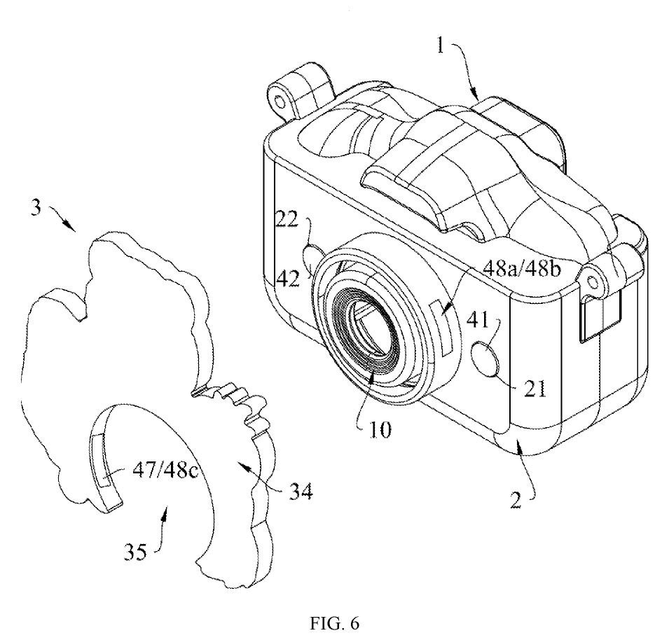

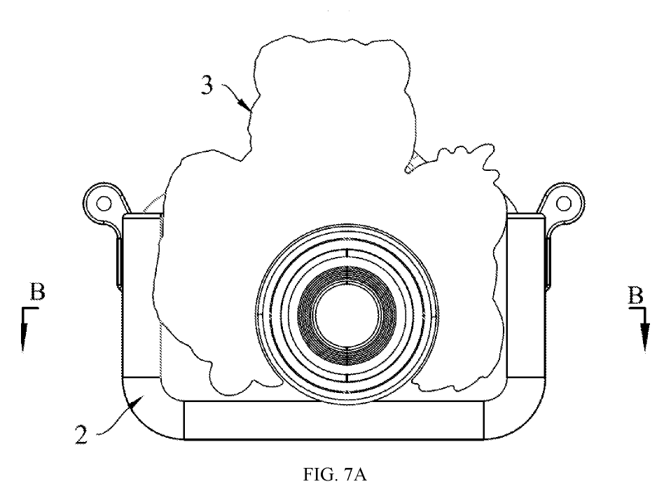

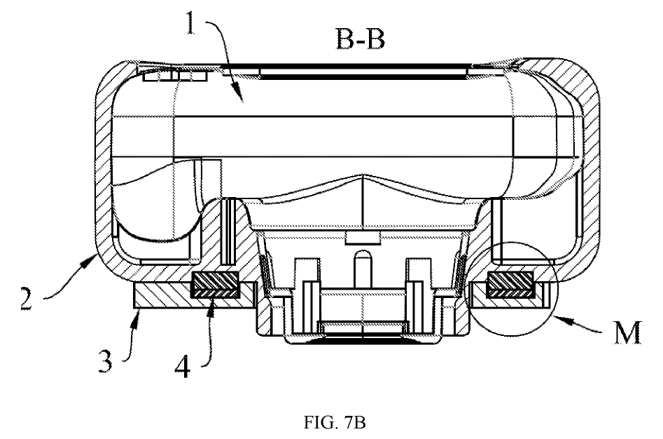

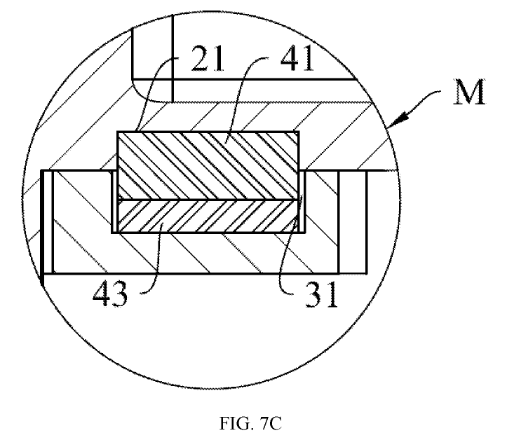

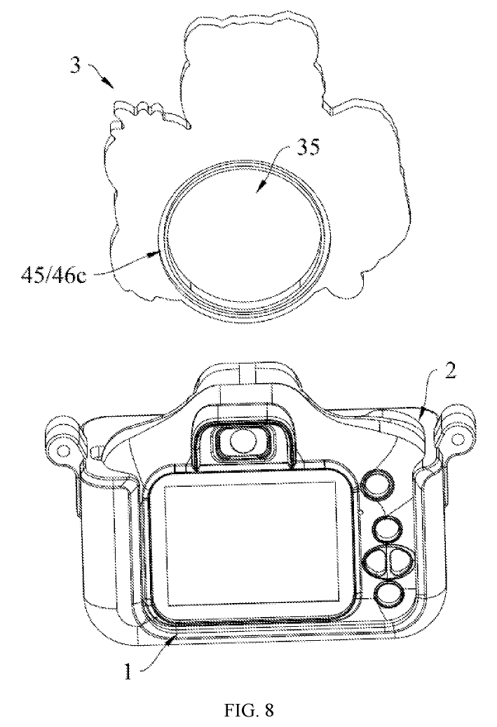

As shown in FIGS. 1 to 8, according to an embodiment of the present disclosure, a children’s camera case 2 sleeved on a camera 1 is disclosed. The children’s camera case 2 includes a housing 20, a card 3, and a magnetic attraction assembly 4. The housing 20 is adapted to external dimensions of the camera 1. The card 3 is disposed at the periphery of a lens 10 of the camera 1. The card 3 includes a mounting surface 33 and a display surface 3. The mounting surface 33 is adjacent to the housing 20 and is secured by the magnetic attraction assembly 4. The display surface 34 is used to display patterns, such as interesting, interactive or educational patterns. These patterns may be animal patterns (such as cats, dogs, rabbits, bears, tigers, and elephants), cartoon characters (such as Spider-Man, Superman, and SpongeBob SquarePants), scenic patterns (forests, flowers, and amusement parks), fairy tales (such as Snow White and Mysterious Castle), or transportation vehicles (such as trains, airplanes, and rockets), etc. The card patterns can be provided to greatly enhance the fun and interactivity of the children’s camera case, attracting more children’s attention to focus on the lens 10, making the children more engaged during shooting, and achieving better photo quality. The card 3 and the housing 20 are magnetically connected optionally by the magnetic attraction assembly 4. The design of the mounting surface allows the card to be easily mounted and removed, and the pattern of the display surface can be drawn by DIY to display various interesting patterns to attract children’s attention. The magnetic connection facilitates quick replacement of cards with different patterns, adding more fun and interactivity during shooting.

In some embodiments, the card 3 is made of one or several among board, silicone, polyvinyl chloride PVC, polycarbonate PC, polyurethane PU, polypropylene PP, and thermoplastic polyurethane elastomer TPU.

In some embodiments, the card 3 includes a card slot 35. The inner arc dimension of the card slot 35 is adapted to the outer edge of the lens 10 of the camera 1, ensuring that the card can be accurately mounted around the lens 10 to avoid large misalignment. Meanwhile, the design brings the pattern on the card 3 closer to the lens 10, making it easier to attract children’s attention and helping the children focus more on the area of the lens 10 during shooting, thereby improving the shooting effect. The card slot 35 is circular or arc-shaped, and the edge of the card slot 35 is adapted to the outer edge of the lens 10 of the camera.

In some embodiments, the children’s camera case further includes a lens through hole 23 provided in the housing 20. The lens 10 of the camera 1 may protrude from inside the lens through hole 23 to the outside when assembling.

In some embodiments, after the card 3 is magnetically connected to the housing 20, at least a portion of the card 3 is located directly above the lens through hole 23, making it easier for the children to focus their eyes on the lens 10 during shooting, thereby improving the shooting effect. The card 3 is provided above or around the lens 10, and can serve as a visual guidance tool to help the children focus their eyes on the lens 10 and reduce distraction.

In some embodiments, the children’s camera case further includes a lens collar 24 disposed on a peripheral side of the lens through hole 23. The lens collar 24 is sleeved at the periphery of the lens 10 after the camera 1 fits with the camera case 2. The card slot 35 is adapted to the shape of the lens collar 24 to ensure that the card can be securely mounted around the lens 10, bringing the pattern on the card 3 closer to the lens 10.

In some embodiments, an outer surface of the housing 20 and the mounting surface 33 of the card 3 are provided with placement slots respectively. The magnetic attraction assembly 4 is secured in the placement slots, and the housing 20 and the card 3 are magnetically connected by the magnetic attraction assembly 4. The placement slots provide additional protection for the magnetic attraction assembly, preventing the card from shifting or loosening during use.

In some embodiments, the housing 20 is provided with a first placement slot 21 and a second placement slot 22 which are disposed at two sides of the lens 10 of the camera 1, respectively, enabling the magnetic attraction of the card 3 is balanced and stable at both sides of the housing 20. Moreover, the first placement slot 21 and the second placement slot 22 may be arranged symmetrically with respect to a center point of the lens 10 of the camera 1, achieving precise locating of the card. The card 3 further includes a third placement slot 31 and a fourth placement slot 32. The third placement slot 31 and the fourth placement slot 32 are disposed corresponding to the first placement slot 21 and the second placement slot 22 in position, respectively. The first magnetic attraction member 41 is magnetically connected to the third magnetic attraction member 43, and the second magnetic attraction member 42 is magnetically connected to the fourth magnetic attraction member 44. The synergistic action of a plurality of magnetic attraction members provides multi-point adsorption force, ensuring that the card can be firmly secured on the housing and will not easily fall off. The corresponding distribution of the magnetic members can effectively disperse the external impact or pulling force, reducing the risk of card loosening due to single-point failure.

In some embodiments, the first magnetic attraction member 41 has a thickness greater than a slot depth of the first placement slot 21, and the second magnetic attraction member 42 has a thickness greater than a slot depth of the second placement slot 22, ensuring that the first magnetic attraction member 41 and the second magnetic attraction member 42 can protrude from the surface of the housing 20 during installation, thereby providing an initial alignment guidance. Meanwhile, the shapes of the first magnetic attraction member 41 and the second magnetic attraction member 42 may be designed according to specific needs, commonly cylindrical, square, etc., to ensure that the first magnetic attraction member 41 and the second magnetic attraction member 42 can be stably embedded in the placement slots and provide sufficient adsorption force. The third magnetic attraction member 43 has a thickness smaller than a slot depth of the third placement slot 31, such that the first magnetic attraction member 41 is partially accommodated in the third placement slot 31 when the first magnetic attraction member 41 is magnetically connected to the third magnetic attraction member 43. The fourth magnetic attraction member 44 has a thickness smaller than a slot depth of the fourth placement slot 32, such that the second magnetic attraction member 42 is partially accommodated in the fourth placement slot 32 when the second magnetic attraction member 42 is magnetically connected to the fourth magnetic attraction member 44. By providing the initial alignment guidance, it is ensured that the first magnetic attraction member 41 and the second magnetic attraction member 42 can more accurately enter the corresponding third placement slot 31 and fourth placement slot 32, so as to precisely locate the positional relationship between the card 3 and the housing 20. The connection stability between the card 3 and the housing 20 is enhanced through the close contact surface and magnetic attraction. In addition, in the above embodiment, the positions of the first placement slot 21 and the third placement slot 31 are interchangeable, and the positions of the second placement slot 22 and the fourth placement slot 32 are also interchangeable. This means that even if the positions of the first magnetic attraction member 41 and the third magnetic attraction member 43 are interchanged, or the positions of the second magnetic attraction member 42 and the fourth magnetic attraction member 44 are interchanged, the original locating relationship can be maintained unchanged, thereby ensuring that the overall functionality and performance of the card 3 and the housing 20 are not affected.

In some embodiments, the first magnetic attraction member 41, the second magnetic attraction member 42, the third magnetic attraction member 43, and the fourth magnetic attraction member 44 are all in flat cylindrical shapes. Flat cylindrical magnetic attraction members can provide uniform adsorption force to ensure a more secure connection between the card and the housing. Due to the relatively large and evenly distributed contact areas of the cylindrical surfaces, loosening or shifting caused by uneven localized force can be avoided. The identical cylindrical design adopted by all the magnetic attraction members ensures a consistent adsorption force at all points and enhances the overall stability.

In some embodiments, among the first magnetic attraction member 41 and the third magnetic attraction member 43, as well as the second magnetic attraction member 42 and the fourth magnetic attraction member 44, one of the first magnetic attraction member 41 and the third magnetic attraction member 43 is a permanent magnet, and the other is either a permanent magnet or a metal body made of iron, cobalt, and nickel. One of the second magnetic attraction member 42 and the fourth magnetic attraction member 44 is a permanent magnet, and the other is either a permanent magnet or a metal body made of iron, cobalt, and nickel.

The cylindrical magnetic attraction members are easy to assemble in the placement slots, and a user is easier to align the position during installation, which reduces the difficulty of installation. The cylindrical design allows the magnetic attraction members to be quickly embedded into the corresponding placement slots and be quickly removed when disassembly is required, making the process convenient and efficient. The cylindrical magnetic attraction members have good pressure resistance and can maintain the shape unchanged under an external pressure, thereby prolonging the service life.

In some embodiments, the card 3 is provided with a groove in an inner arc surface of its card slot 35, and a seventh magnetic attraction member 47 is mounted inside the groove. The card 3 is magnetically connected to an outer surface of the lens 10 of the camera 1 optionally by the seventh magnetic attraction member 47. By providing the seventh magnetic attraction member 47 to make the card 3 magnetically connected to the outer surface of the lens 10 of the camera 1, the fixation and stability of the card 3 are enhanced. The seventh magnetic attraction member 47 increases the adsorption force between the card 3 and the lens, preventing the card from shifting or loosening during use.

In some embodiments, the card 3 is provided with a groove in the inner arc surface of its card slot 35, and a seventh magnetic attraction member 47 is mounted inside the groove. A strip- and arc-shaped groove is provided in an outer surface and/or an inner surface of the lens collar 24, and a strip- and arc-shaped eighth magnetic attraction member 48a is provided inside the groove of the lens collar 24. The card 3 is magnetically connected to the outer surface of the lens collar 24 optionally by the seventh magnetic attraction member 47 and the eighth magnetic attraction member 48a. In the above embodiments, when the strip- and arc-shaped groove is defined in the outer surface of the lens collar 24, the seventh magnetic attraction member 47 may be partially accommodated in the groove of the lens collar 24, or the eighth magnetic attraction member 48a may be partially accommodated in the groove of the card 3 for locating and preventing relative sliding between the seventh magnetic attraction member 47 and the eighth magnetic attraction member 48a after being magnetically connected.

In some embodiments, the card 3 is provided with a groove in the inner arc surface of its card slot 35, and a metal body 48c made of iron, cobalt, nickel, etc. is mounted inside the groove. A strip- and arc-shaped groove is provided in the outer surface and/or the inner surface of the lens collar 24, and a strip and arc-shaped eighth magnetic attraction member 48a is provided inside the groove. The card 3 is magnetically connected to the outer surface of the lens collar 24 optionally by the metal body 48c and the eighth magnetic attraction member 48a. In the above embodiments, when the groove is defined in the outer surface of the lens collar 24, the metal body 48c may be partially accommodated in the strip- and arc-shaped groove of the lens collar 24, or the eighth magnetic attraction member 48a may be partially accommodated in the groove in the inner side of the card 3 for locating and preventing relative sliding between the metal body 48c and the eighth magnetic attraction member 48a after being magnetically connected.

In some embodiments, the card 3 is provided with a groove in the inner arc surface of its card slot 35, and a seventh magnetic attraction member 47 is mounted inside the groove. A groove is provided in the outer surface and/or the inner surface of the lens collar 24, and a metal body 48b made of iron, cobalt, and nickel is mounted inside the groove. The card 3 is magnetically connected to the outer surface of the lens collar 24 optionally by the seventh magnetic attraction member 47 and the metal body 48b. In the above embodiments, when the groove is defined in the outer surface of the lens collar 24, the seventh magnetic attraction member 47 may be partially accommodated in the groove of the lens collar 24, or the metal body 48b may be partially accommodated in the groove of the card 3 for locating and preventing relative sliding between the seventh magnetic attraction member 47 and the metal body 48b after being magnetically connected.

The seventh magnetic attraction member 47, the eighth magnetic attraction member 48a, or the metal body 48b made of iron, cobalt, and nickel may be a strip- and arc-shaped magnetic attraction member or a thin planar magnetic attraction member, and may be in circular, square, strip and arc shape, or other shapes. The strip- and arc-shaped magnet can better fit the shape of the lens collar 24 and provides a stable magnetic connection, ensuring a closer contact between the card and the lens collar 24. This design can reduce gaps and improve adsorption and stability. The thickness of the strip- and arc-shaped magnetic attraction members should be moderate to provide sufficient adsorption force without affecting the overall thickness of the card or the lens collar.

In some embodiments, the card 3 is provided with a groove in a peripheral side of its card slot 35, and a fifth magnetic attraction member 45 is provided inside the groove. The housing 20 is provided with a groove in a peripheral side of its lens through hole 23, and a sixth magnetic attraction member 46a is provided inside the groove, allowing the card 3 to be magnetically connected to the housing 20 optionally by the fifth magnetic attraction member 45 and the sixth magnetic attraction member 46a. The magnetic attraction between the fifth magnetic attraction member 45 and the sixth magnetic attraction member 46a forms a tight contact surface, enhancing the stability of the connection between the card 3 and the housing 20. The fifth magnetic attraction member 45 and the sixth magnetic attraction member 46a are located around the card slot 35 of the card 3 and the lens through-hole 23 of the housing 20, respectively. This positional relationship provides an initial alignment guidance for the installation of the card 3, ensuring that the card can be quickly and accurately docked with the housing 20, and reducing the possibility of mis-operation. In the above embodiments, the fifth magnetic attraction member 45 may be partially accommodated in the groove of the housing 20, or the sixth magnetic attraction member 46a may be partially accommodated in the groove of the card 3 for locating and preventing sliding between the fifth magnetic attraction member 45 and the sixth magnetic attraction member 46a after being magnetically connected.

In some embodiments, the card 3 is provided with a groove in the peripheral side of its card slot 35, and a metal body 46c made of iron, cobalt, and nickel is provided inside the groove. The housing 20 is provided with a groove in the peripheral side of its lens through-hole 23, and a sixth magnetic attraction member 46a is provided inside the groove, allowing the card 3 to be magnetically connected to the housing 20 optionally by the metal body 46c and the sixth magnetic attraction member 46a. In the above embodiments, the metal body 46c may be partially accommodated in the groove of the housing 20, or the sixth magnetic attraction member 46a may be partially accommodated in the groove of the card 3 for locating and preventing sliding between the metal body 46c and the sixth magnetic attraction member 46a after being magnetically connected.

In some embodiments, the card 3 is provided with a groove in the peripheral side of its card slot 35, and a fifth magnetic attraction member 45 is provided inside the groove. The housing 20 is provided with a groove in the peripheral side of its lens through hole 23, and a metal body 46b made of iron, cobalt, and nickel is provided inside the groove, allowing the card 3 to be magnetically connected to the housing 20 optionally by the fifth magnetic attraction member 45 and the metal body 46b. In the above embodiments, the fifth magnetic attraction member 45 may be partially accommodated in the groove of the housing 20, or the metal body 46b may be partially accommodated in the groove of the card 3 for locating and preventing sliding between the fifth magnetic attraction member 45 and the metal body 46b after being magnetically connected.

In the above embodiments, the magnetic attraction members and the metal bodies are located at key positions of the card 3 and the housing 20, i.e., around the card slot 35 and the lens through hole 23, respectively. This positional relationship provides an initial alignment guidance for the installation of the card 3, ensuring that the card can be accurately docked with the housing 20. In this way, the card 3 is less prone to shifting or loosening after installation, ensuring the stability of a device during use.

The fifth magnetic attraction member 45 and the sixth magnetic attraction member 46a may be annular magnets, or magnets formed by broken segments around the periphery of the lens.

In some embodiments, among the first magnetic attraction member 41, the second magnetic attraction member 42, the third magnetic attraction member 43, the fourth magnetic attraction member 44, the fifth magnetic attraction member 45, the sixth magnetic attraction member 46a, and the seventh magnetic attraction member 47, the corresponding magnetic attraction members may be one or a combination of a permanent magnet, an electromagnet, a soft magnetic material, an rare earth magnet, a bonded magnet, or a flexible magnet. Different types of magnetic attraction members can be selected according to specific needs, providing a wide range of possibilities to meet the demands of different application scenarios. High-performance magnets (e.g., Neodymium Iron Boron NdFeB) provide strong magnetic force to ensure that the card can be firmly secured to the housing. Soft magnetic materials are suitable for high-frequency applications, improving the energy efficiency and prolonging the service life. The bonded and flexible magnets have good moldability and processability, making them suitable for designs with complicated shapes. Rare earth magnets have excellent high-temperature resistance and corrosion resistance, improving the reliability and durability of the connection.

The above are only some embodiments of the present disclosure and are not intended to limit the present disclosure. Various changes and variations may be made to the present disclosure for those skilled in the art. Any modifications, equivalent substitutions, improvements, etc. made within the spirit and principles of the present disclosure shall fall within the scope of protection of the present disclosure.

What is claimed is:

1. A children’s camera case (2) configured to be sleeved on a camera (1), wherein the children’s camera case (2) comprises:
a housing (20), adapted to external dimensions of the camera (1);
a card (3), disposed at a periphery of a lens (10) of the camera (1); and
a magnetic attraction assembly (4), a part of the magnetic attraction assembly (4) being provided in the housing (20), and another part of the magnetic attraction assembly (4) being provided in the card (3), the card (3) configured to be magnetically connected to the housing (20) by the magnetic attraction assembly (4).

2. The children’s camera case (2) according to claim 1, wherein:
the card (3) comprises a card slot (35) having an inner arc dimension adapted to an outer edge of the lens (10) of the camera (1).

3. The children’s camera case (2) according to claim 2, wherein:
the card slot (35) is circular or arc-shaped, and an edge of the card slot (35) is adapted to the outer edge of the lens (10) of the camera (1).

4. The children’s camera case (2) according to claim 2, wherein:
the children’s camera case further comprises:
a lens through hole (23) provided in the housing (20), wherein the lens (10) of the camera (1) protrudes from an inside of the lens through-hole (23) to an outside of the lens through-hole (23).

5. The children’s camera case (2) according to claim 4, wherein:
the children’s camera case further comprises:
a lens collar (24) disposed on a peripheral side of the lens through hole (23), wherein the lens collar (24) is sleeved at the periphery of the lens (10) of the camera (1) in response to the camera (1) being fitted with the camera case (2); and
the card slot (35) is adapted to a shape of the lens collar (24).

6. The children’s camera case (2) according to claim 1, wherein:
the card (3) comprises a mounting surface (33) and a display surface (34), the mounting surface (33) is adjacent to the housing (20) and is secured by the magnetic attraction assembly (4), and the display surface (34) is configured to display patterns.

7. The children’s camera case (2) according to claim 6, wherein:
an outer surface of the housing (20) and the mounting surface (33) of the card (3) are provided with placement slots respectively, and the magnetic attraction assembly (4) is fixedly mounted in the placement slots.

8. The children’s camera case (2) according to claim 1, wherein:
the housing (20) is further provided with a first placement slot (21) and a second placement slot (22) each disposed at one of two sides of the lens (10) of the camera (1), respectively;
the card (3) further comprises a third placement slot (31) and a fourth placement slot (32) which are disposed corresponding to positions of the first placement slot (21) and the second placement slot (22), respectively;
the magnetic attraction assembly (4) comprises a first magnetic attraction member (41), a second magnetic attraction member (42), a third magnetic attraction member (43), and a fourth magnetic attraction member (44) each fixedly disposed in the first placement slot (21), the second placement slot (22), the third placement slot (31), and the fourth placement slot (32), respectively; and
the card (3) is fixedly connected to the housing (20) in response to the first magnetic attraction member (41) being magnetically connected to the third magnetic attraction member (43) and the second magnetic attraction member (42) being magnetically connected to the fourth magnetic attraction member (44).

9. The children’s camera case (2) according to claim 4, wherein:
at least a portion of the card (3) is located directly above the lens through-hole (23) in response to the card (3) being magnetically connected to the housing (20).

10. The children’s camera case (2) according to claim 5, wherein:
the card (3) is made of at least one of wood, silicone, polyvinyl chloride (PVC), polycarbonate (PC), polyurethane (PU), polypropylene (PP), or thermoplastic polyurethane elastomer (TPU).

11. The children’s camera case (2) according to claim 2, wherein:
the card (3) is provided with a seventh magnetic attraction member (47) on an inner side of the card slot (35), and the card (3) is configured to be magnetically connected to an outer surface of the lens (10) of the camera (1) by the seventh magnetic attraction member (47).

12. The children’s camera case (2) according to claim 8, wherein:
the first placement slot (21) and the second placement slot (22) are arranged symmetrically with respect to a center point of the lens (10) of the camera (1).

13. The children’s camera case (2) according to claim 8, wherein:
the first magnetic attraction member (41) has a thickness greater than a slot depth of the first placement slot (21); and
the second magnetic attraction member (42) has a thickness greater than a slot depth of the second placement slot (22).

14. The children’s camera case (2) according to claim 13, wherein:
the third magnetic attraction member (43) has a thickness smaller than a slot depth of the third placement slot (31), the first magnetic attraction member (41) is partially accommodated in the third placement slot (31) in response to the first magnetic attraction member (41) being magnetically connected to the third magnetic attraction member (43); and
the fourth magnetic attraction member (44) has a thickness smaller than a slot depth of the fourth placement slot (32), the second magnetic attraction member (42) is partially accommodated in the fourth placement slot (32) in response to the second magnetic attraction member (42) being magnetically connected to the fourth magnetic attraction member (44).

15. The children’s camera case (2) according to claim 8, wherein:
the first magnetic attraction member (41), the second magnetic attraction member (42), the third magnetic attraction member (43), and the fourth magnetic attraction member (44) are in flat cylindrical shapes.

16. The children’s camera case (2) according to claim 4, wherein:
a fifth magnetic attraction member (45) is provided on at least one of a peripheral side of the card slot (35) of the card (3) and a peripheral side of the lens through-hole (23) of the housing (20), and a sixth magnetic attraction member (46a) or a magnetizable metal body (46b) is provided on another one of the peripheral side of the card slot (35) of the card (3) and the peripheral side of the lens through-hole (23) of the housing (20), allowing the card (3) to be magnetically connected to the housing (20) by the fifth magnetic attraction member (45) and the sixth magnetic attraction member (46a) or the metal body (46b).

17. The children’s camera case (2) according to claim 16, wherein:
the fifth magnetic attraction member (45) and/or the sixth magnetic attraction member (46a) are annular magnets.

18. The children’s camera case (2) according to claim 5, wherein:
a seventh magnetic attraction member (47) is provided on at least one of an inner side of the card slot (35) of the card (3) and an outer surface of the lens collar (24), and an eighth magnetic attraction member (48a) or a magnetizable metal body (48b) is provided on another one of the inner side of the card slot (35) of the card (3) and the outer surface of the lens collar (24), allowing the card (3) to be magnetically connected to the outer surface of the lens collar (24) by the seventh magnetic attraction member (47) and the eighth magnetic attraction member (48a) or the metal body (48b).

19. The children’s camera case (2) according to claim 18, wherein:
the seventh magnetic attraction member (47) and/or the eighth magnetic attraction member (48a) are strip- arc-shaped magnets.

20. The children’s camera case (2) according to claim 8, wherein:
the first magnetic attraction member (41), the second magnetic attraction member (42), the third magnetic attraction member (43), and the fourth magnetic attraction member (44) are one or a combination of a permanent magnet, an electromagnet, a soft magnetic material, a rare earth magnet, a bonded magnet, or a flexible magnet.
